(19) United States
(12) Patent Application Publication
(10) Pub. No.: US 2012/0012086 A1
(43) Pub. Date: Jan. 19, 2012

(54) VEHICLE CONTROL APPARATUS

(75) Inventors: Keiji Yoeda, Numazu-shi (JP); Kichiro Kato, Sunto-gun (JP); Osamu Igarashi, Toyota-shi (JP); Satoshi Sugiyama, Mishima-shi (JP); Naruto Yamane, Susono-shi (JP)

(73) Assignee: TOYOTA JIDOSHA KABUSHIKI KAISHA, Toyota-shi (JP)

(21) Appl. No.: 13/262,121

(22) PCT Filed: Apr. 1, 2009
(86) PCT No.: PCT/JP2009/056821

§ 371 Date: Sep. 29, 2011

(51) Int. Cl. F02B 33/00

(52) U.S. Cl. 123/559.1

(57) ABSTRACT

In an internal combustion engine provided with a rotary intake control valve, preferable position convergence at the end of inertia supercharging is ensured while avoiding an influence on combustion performance. In an engine provided with an impulse valve, if the implementation of the inertia supercharging is stopped and a request to maintain the impulse valve at a fully-opened position is made, an ECU stops the supply of a braking force to the impulse valve until the rotational phase of the impulse valve enters dead band, and the ECU performs a BRK mode for stopping the impulse valve under the condition that the rotational phase enters the dead band and that the impulse valve is in a deceleration state. At this time, electrification or power distribution for acceleration of the impulse valve during stop control of the impulse valve is forbidden. Moreover, the converging position of the impulse valve by the BRK mode is allowed to deviate in a range with an allowable width set in advance with respect to a target.

### TECHNICAL FIELD

The present invention relates to a vehicle control apparatus for controlling a vehicle provided with an internal combustion engine configured to perform inertia supercharging by using the open/close control of an intake control valve.

### BACKGROUND ART

As this type of apparatus, there has been suggested an apparatus intended to prevent over/undershooting of the intake control valve (e.g. refer to a patent document 1). According to the intake control apparatus of an internal combustion engine disclosed in the patent document 1, the over/undershooting for a target stop position can be prevented by providing the rotating shaft of the intake control valve with first and second link levers which have different amount of a turn.

Incidentally, the inertia supercharging is also disclosed, for example in a patent document 2.

Moreover, there has been also suggested an apparatus which has a turn-style intake control valve and which is to prevent backflow of intake air which takes place in the latter half of the valve opening period of an intake valve (e.g. refer to a patent document 3).
Patent document 1: Japanese Patent Application Laid Open No. Hei 5-79335
Patent document 2: Japanese Patent Application Laid Open No. Hei 5-156951
Patent document 3: Japanese Patent Application Laid Open No. Hei 2-86920

### DISCLOSURE OF INVENTION

### Subject to be Solved by the Invention

In cases where the intake control valve is a rotary intake control valve which rotates in one direction in an intake passage, if the inertial supercharging is ended to stop the intake control valve in a fully-opened state or in a similar valve opening state, the overshooting for the target position needs to be avoided. Thus, inevitably, it takes a reasonable time to convergence of a stop position. Therefore, in ending the inertial supercharging, an intake stroke tends to be greatly influenced, and the combustion performance of the internal combustion engine tends to be deteriorated.

On one hand, if the technology disclosed in the patent document 1 is applied to such a problem, it necessitates the provision of the link lever and causes an increase in cost and a deterioration in vehicle installation performance. Thus, it could hardly be a solution. On the other hand, if it is intended to increase the capacity of a braking/driving force which can be supplied to the intake control valve to obtain a relatively large braking force, the original merits of the rotary intake control valve that it is highly efficient will disappear. Incidentally, since the patent documents 2 and 3 do not disclose the position control of the intake control valve performed at the end of inertia supercharging, this type of problem is hardly avoided in the same manner.

In other words, the conventional technology illustrated in the aforementioned various patent documents have such a technical problem that it is hard to efficiently converge the position of the intake control valve while eliminating an influence on the combustion performance as much as possible in stopping the inertia supercharging. In view of the aforementioned problems, it is therefore an object of the present invention to provide a vehicle control apparatus capable of ensuring preferable position convergence at the end of inertia supercharging while avoiding the influence on the combustion engine as much as possible.

### Means for Solving the Subject

The above object of the present invention can be achieved by a vehicle control apparatus for controlling a vehicle, the vehicle provided with: a plurality of cylinders; intake valves each corresponding to respective one of the plurality of cylinders; an intake passage communicated with the plurality of cylinders; a rotary intake control valve which is rotatably disposed in the intake passage and which is in a valve-opening state and a valve-closing state in a predetermined rotational phase; an internal combustion engine which enables inertial supercharging using intake pulsation, by that the rotational phase of the intake control valve is controlled in synchronization with an opening/closing phase of the intake valve; and a braking/driving force supplying device capable of supply a braking/driving force for promoting a change in the rotational phase to the intake control valve, the vehicle control apparatus provided with: a specifying device for specifying operating conditions of the vehicle associated with necessity of performing the inertia supercharging; and a controlling device for controlling the braking/driving force supplying device such that a braking force accompanied by deceleration of the intake control valve is supplied as the braking/driving force if the specified operating conditions correspond to a stop request to stop the inertia supercharging while maintaining the intake control valve in the valve opening state in a period for performing the inertia supercharging and such that the supply of the braking force is started in a dead band indicating a range of the rotational phase corresponding to the valve closing state.

The vehicle control apparatus of the present invention can adopt forms of a single various computer system or a plurality of various computer systems, such as microcomputer apparatuses, a single various controller or a plurality of various controllers, a single various processing unit or a plurality of various processing units, such as ECUs (Electronic Controlled Unit), which can appropriately include various memory devices such as a buffer memory, a flash memory, a RAM (Random Access Memory) or a ROM (Read Only Memory), one various controller or a plurality of controllers, one various processor or a plurality of various processors, one MPU (Micro Processing Unit) or a plurality of MPUs, one CPU (Central Processing Unit) or a plurality of CPUs, etc.

The internal combustion engine of the present invention is an engine capable of converting fuel combustion to mechanical power. The physical, mechanical, or electrical configuration thereof, such as a fuel type, a fuel supply aspect, a fuel combustion aspect, structure of an intake/exhaust system and cylinder arrangement, is not particularly limited; however, particularly in the present invention, the rotary intake control valve is disposed in the intake passage. Here, the “intake passage” is a passage for intake air conceptually including incoming air, a mixed gas in which an inert gas such as an EGR gas is mixed with the incoming air, an air-fuel mixture in which atomized fuel is mixed with the incoming air or the mixed gas, and the like. As a preferred form, the intake passage can adopt, for example, a form of a single or plurality of tubular members, which enable, for example, an air cleaner, an airflow meter, a throttle valve (i.e. intake throttle valve), a surge tank, an intake port and the like to be connected to or communicated with each other as occasion demands.

The intake control valve of the present invention is a rotary valve which is driven in one rotational direction set in advance and which adopts either the valve opening state or the valve closing state in accordance with the rotational phase (simply, rotation angle) which changes, for example, in a binary, stepwise, or continuous manner. Incidentally, the rotational phase corresponding to the valve closing state is the dead band in which there is strictly or substantially no flow change in the intake air via the intake control valve with respect to the change in the rotational phase, or which is such a range that there is practically no problem even if it is treated as if there were no flow change.

The intake control valve is disposed on the downstream side of an intake throttle valve (incidentally, the “downstream” is one concept of direction based on a direction in which a gas flows, and in this case, namely, the cylinder side), as a preferred form, if the internal combustion engine is provided with the so-called intake throttle valve such as a throttle valve. The placement aspect of the intake control valve can be changed as occasion demands, in accordance with the structure, configuration, etc. of the intake passage. For example, if the intake passage has such a structure that it appropriately diverges correspondingly to each cylinder or a cylinder group for example in a section between the surge tank and each cylinder, a single intake control valve may be provided at its diverging position or on its upstream side in a form of being shared with a plurality of cylinders (in this case, an intake system can adopt a so-called one valve type intake system without an intake manifold as a preferred form). Even in such a structure of the intake passage, a plurality of intake control valves (for example, including a so-called multiple valve type intake system without an intake manifold etc.) may be provided individually for the respective cylinders in a plurality of intake passages corresponding to the respective cylinders (i.e. on the downstream side of the diverging position). Alternatively, if one portion of the intake passage is independent in each cylinder, for example on the surge tank downstream side, such as a so-called intake manifold, of course, the intake control valve may be provided in each (or one portion) of the independent tube lines. Incidentally, in the intake control valve, the change in the rotational phase is promoted by the braking/driving force conceptually including a braking force and a driving force, which is supplied from the braking/driving force supplying device such as a motor and an actuator of an electrically-driven type in accordance with its drive voltage, drive current, or the like.

The internal combustion engine of the present invention can perform the inertia supercharging (also referred to as pulse supercharging or impulse charging or the like) using the intake pulsation, by the control of the rotational phase of the intake control valve performed in synchronization with the opening/closing phase of the intake valve (incidentally, the “synchronization” in the present invention is not necessarily limited to matching or coincidence but means that a correspondence relation between the two or a criterion for defining the correspondence relation is established). Here, the “inertia supercharging” indicates, as a preferred form, taking a large amount of intake air into the cylinders in the intake stroke (i.e. supercharging), in comparison with natural aspiration (as a preferred form, the intake air can be taken into the cylinders basically as a pulsating wave, with or without the intake control valve; however, the pulsation resulting from the open/close control performed on the intake control valve is, as a preferred form, stronger than this type of pulsation) using the intake pulsation which can adopt a so-called secondary positive-pressure wave, wherein the secondary positive-pressure results from that a positive-pressure wave is generated, for example by closing the intake control valve in tandem with the valve opening of the intake valve and by opening the intake control valve after a lapse of proper time (which may be defined, as an angle concept, by a crank angle etc.) after the valve opening of the intake valve (i.e. by opening the valve in the state that the pressure on the downstream side of the intake control valve is negative and that the pressure on the upstream side of the intake control valve is atmospheric pressure or more) or the like, that the positive-pressure wave is reflected as a negative-pressure wave in the vicinity of entrance of a combustion chamber in each cylinder which can be regarded as an opening end, and that the negative-pressure wave is open-end-reflected again at an opening part such as a surge tank, arranged in series or in parallel with respect to the intake passage.

The control of the rotational state of the intake control valve performed to realize this type of inertia supercharging can adopt various aspects. For example, it conceptually includes the control of the opening/closing phase, opening/closing time, valve opening period or opening degree (which is namely the degree of valve opening and which uniquely defines an opening/closing state) of the intake control valve, the control of the opening/closing phase, opening/closing time or valve opening period of the intake valve, or moreover, the correction of the amount of fuel injection according to a change in the amount of the intake air accompanied by a change in the filling efficiency of the intake air, and the like. For example, it also includes, in effect, control for matching or substantially matching the valve closing time of the intake valve (i.e. a valve for controlling a communication state between the combustion chamber and the intake passage as a preferred form) with the time that the peak of a pulsation wave (positive-pressure wave) of the intake air reaches the intake valve.

According to the vehicle control apparatus of the present invention, in its operation, various operating conditions of the vehicle, including load information such as for example an accelerator opening degree and rotation information on an engine rotational speed, associated with the necessity of performing the inertia supercharging are specified by the specifying device. Moreover, if the specified operating conditions correspond to the stop request in the period for performing the inertia supercharging, the braking/driving force supplying device is controlled by the controlling device such that the braking force is supplied to the intake control valve. Incidentally, the wording “specify” conceptually includes detect, estimate, identify, derive, calculate, obtain, and the like, and its practical aspect is not limited.

Here, the “stop request” is a request to stop the inertia supercharging while maintaining the intake control valve in the valve opening state, desirably in a fully-opened state or in a substantially fully-opened state similar thereto. If the supply of the braking force is simply started without any guidance in accordance with the stop request, there will likely be the following problems in practice.

For example, in a so-called transitional braking period from when the intake control valve is driven in accordance with drive conditions defined to perform the inertia supercharging to when the intake control valve is stopped in the valve opening state, a time change in the rotational phase of the intake control valve deviates to no small extent from that in the period for performing the inertia supercharging. Therefore, in the cylinder that enters the intake stroke in the braking period, its intake amount changes to no small extent. The change in the intake amount influences a combustion state in the cylinder. As a result, as the number of the cylinders that enter the intake stroke in the braking period increases, the combustion state of the internal combustion engine deteriorates.

Moreover, for the reasons that the extent of a range of the rotational phase corresponding to the valve opening state is different from the extent of a range corresponding to the dead band, or that the extent of a range of the opening/closing phase of the intake valve to maintain the intake control valve in the valve opening state is different from the extent of a range of the opening/closing phase of the intake valve to maintain the intake control valve in the valve closing state, or for similar reasons, the intake control valve rarely adopts a uniform (constant speed) rotation state in most cases in the period for performing the inertia supercharging. In other words, the intake control valve preferably repeats acceleration and deceleration in a one-rotation period. Therefore, for example, if the supply of the braking force is started accidentally in an acceleration period, it may take a long time to stop the intake control valve. In particular, in the rotary intake control valve, since the rotational phase changes in one direction, it is not preferable that the overshooting occurs. Moreover, in order to maintain the merits of the rotary intake control valve that it is efficient in energy consumption, it is also hardly possible to increase the physical, mechanical, or electrical body of the braking/driving force supplying device. Thus, such problems are notable.

In contrast, according to the vehicle control apparatus of the present invention, the controlling device controls the braking/driving force supplying device such that the supply of the braking force is started in the dead band (i.e. the range of the rotational phase corresponding to the valve closing state), in response to the stop request. More specifically, for example, if the intake control valve is in the rotational phase corresponding to the valve opening state, there is taken such a measure as postponing the supply of the braking force until the rotational phase enters the dead band or the like. As a result, with regard to the cylinder that is actually filled with the intake air using the inertial supercharging at the time point that the stop request is made, the inertia supercharging is normally performed. Thus, it is possible to reduce the number of the cylinders in which the intake stroke is influenced, as much as possible. As a result, the deterioration in the combustion performance caused by the change in the intake amount can be suppressed as much as possible.

Further to that, if the braking force accompanied by the deceleration of the intake control valve is applied to the intake control valve, there can be the change in the intake amount as described above; however, if the start timing of the braking force is set in the dead band, the intake stroke in which the braking force influences the intake air can be extended as long as possible. This makes it possible to reduce the number of the cylinders in which the braking force causes a change in intake characteristics, as much as possible. Considering that the rotational phase corresponding to the valve closing state (i.e. the dead band) and the rotational phase corresponding to the valve opening state alternately appear in the intake control valve, in cases where it is intended to stop the intake control valve in the valve opening state, if the supply of the braking force is started in the valve opening period of the intake control valve, the probability that the rotational phase passes through the dead band at least once is high. In other words, the possibility that a plurality of intake strokes are influenced is high.

Moreover, from the viewpoint of position convergence, it is preferable that the supply of the braking force is started in the dead band because it increases a time provided for the position convergence with respect to the target state of the intake control valve, which is desirably the fully-opened state or the substantially fully-opened state.

As described above, according to the vehicle control apparatus of the present invention, in stopping the inertia supercharging, it is possible to ensure the preferable position convergence of the intake control valve while avoiding the influence on the combustion chamber as much as possible.

In one aspect of the vehicle control apparatus of the present invention, the intake control valve is supplied with the braking force in a former half portion of the dead band, a driving force accompanied by acceleration of the intake control valve in a latter half portion of the dead band, the driving force in a former half portion of the rotational phase corresponding to the valve opening state connected to the latter half portion of the dead band, and the braking force in a latter half portion of the rotational phase corresponding to the valve opening state connected to the former half portion of the dead band, by the braking/driving force supplying device in the period for performing the inertia supercharging.

According to this aspect, as described above, for the reasons that the extent of the range of the rotational phase corresponding to the valve opening state is different from the extent of the range corresponding to the dead band, or that the extent of the range of the opening/closing phase of the intake valve to maintain the intake control valve in the valve opening state is different from the extent of the range of the opening/closing phase of the intake valve to maintain the intake control valve in the valve closing state, or for similar reasons, the intake control valve is driven while repeating the acceleration and the deceleration in the period for performing the inertia supercharging.

According to this aspect, the start timing of the braking force is set in a period in which the braking force is originally supplied, in the dead band. Thus, in comparison with cases where the intake control valve is stopped from the acceleration state due to the driving force, the intake control valve can be stopped more quickly.

In another aspect of the vehicle control apparatus of the present invention, the braking force is supplied by stopping the supply of the driving force or by supplying the driving force in a direction of inverse rotation.

The braking force of the present invention is a force accompanied by the deceleration. Thus, the braking force can be also supplied by stopping the driving force supplied in this manner, or by supplying the driving force in the direction of inverse rotation.

In another aspect of the vehicle control apparatus of the present invention, the controlling device controls the braking/driving force supplying device such that a stop position of the intake control valve resulting from the supply of the braking force is included in an allowable range with respect to a target stop position set in a range of the rotational phase corresponding to the valve opening state.

According to this aspect, the allowable range is set with respect to the target stop position, by which the intake control valve can be stopped without much effort. Here, the “allowable range” is preferably set such that a change in the state of the internal combustion engine or the vehicle caused by the deviation of the stop position of the intake control valve with respect to the target stop position (e.g. an increase in pumping loss, the deterioration of emission, or the lack of torque, caused by the insufficient intake amount) can be small enough to overlook or ignore it in practice, on the basis of experiments, experiences, theories, simulations, or the like in advance. For example, if the stop position of the intake control valve is close to the dead band, even if the intake throttle valve located on the upstream side of the intake control valve is fully opened, it is hard to obtain a sufficient intake amount. On the other hand, in the rotational phase in the vicinity of a fully-opened position, the change in the intake amount is small with respect to the change in the rotational phase. Thus, particularly, if the target stop position is the fully-opened position, a certain range can be allowed as the allowable range.

In another aspect of the vehicle control apparatus of the present invention, it is further provided with a first correcting device for correcting amount of fuel injection of the internal combustion engine in accordance with a deviation between a stop position of the intake control valve resulting from the supply of the braking force and a target stop position set in a range of the rotational phase corresponding to the valve opening state.

According to this aspect, by the first correcting device, the amount of the fuel injection is corrected in the transitional period in which the braking force for stopping the intake control valve is supplied to the intake control valve, in accordance with the deviation between the target stop position and an actual stop position or a stop position assumed in advance. Thus, the deterioration of emission resulting from the change in the intake amount is prevented, which is preferable.

In another aspect of the vehicle control apparatus of the present invention, it is further provided with a second correcting device for correcting amount of fuel injection of the internal combustion engine to a reduction side if the specified operating conditions correspond to the stop request.

According to this aspect, by the second correcting device, the amount of the fuel injection is reduced if the specified operating conditions correspond to the stop request. Thus, it is possible to ease or reduce a torque shock and to prevent the generation of smoke or the like.

The operation and other advantages of the present invention will become more apparent from the embodiment explained below.

### BRIEF DESCRIPTION OF DRAWINGS

FIG. 1 is a schematic configuration diagram conceptually showing the structure of an engine system in a first embodiment of the present invention.

FIG. 2 is a schematic cross sectional view showing an intake tube near an impulse valve in the engine system in FIG. 1.

FIG. 3 is a flowchart showing impulse valve control performed in the engine system in FIG. 1.

FIG. 4 is a conceptual view showing an operating mode selection map referred to in the impulse valve control in FIG. 3.

FIG. 5 is a schematic diagram illustrating a temporal transition in the operating state of the impulse valve in a process of performing the impulse valve control in FIG. 3.

FIG. 6 is a schematic diagram illustrating a temporal transition in the operating state of the impulse valve to be used for a comparative study with FIG. 5 and associated with the effect of the embodiment.

FIG. 7 is a schematic diagram illustrating a temporal transition in the operating state of an engine in the process of performing the impulse valve control in FIG. 3.

FIG. 8 is a schematic diagram illustrating a temporal transition in the operating state of the engine to be used for a comparative study with FIG. 6 and associated with the effect of the embodiment.

### DESCRIPTION OF REFERENCE CODES engine system

100 ECU
200 engine
202 cylinder
204 intake tube
205 throttle valve
206 communicating tube
207 intake valve
216 turbine
218 compressor
222 intercooler
   223 surge tank
224 impulse valve
225 actuator

### BEST MODE FOR CARRYING OUT THE INVENTION

### Embodiment of the Invention

Hereinafter, various preferred embodiments of the present invention will be explained with reference to the drawings.

### Structure of Embodiment

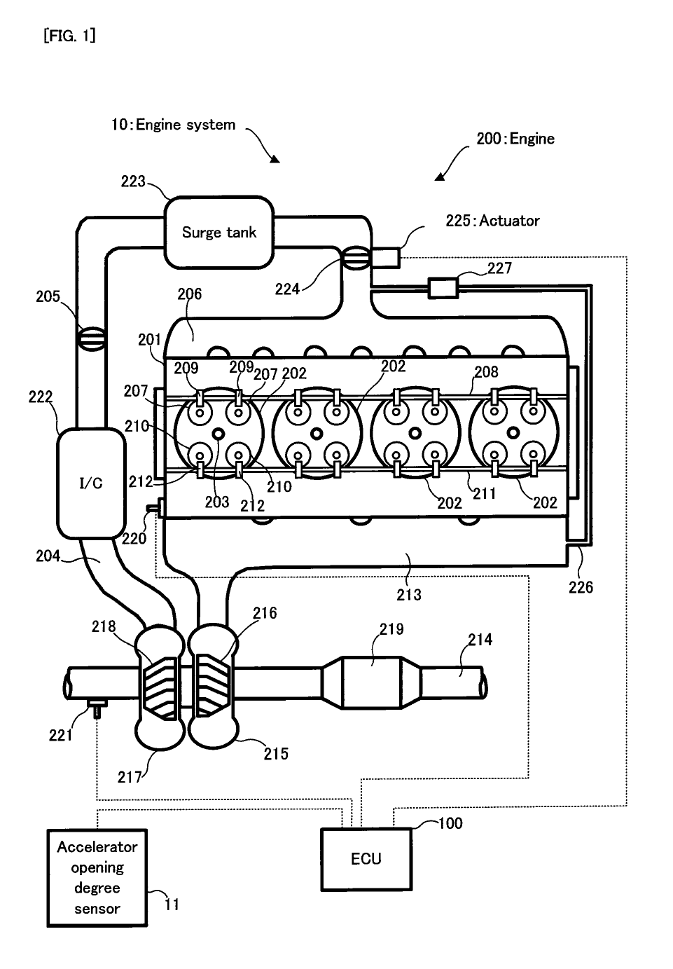

Firstly, with reference to FIG. 1, an explanation will be given on the structure of an engine system 10 in an embodiment of the present invention. FIG. 1 is a schematic configuration diagram conceptually showing the structure of the engine system 10.

In FIG. 1, the engine system 10 is installed on a not-illustrated vehicle, and it is provided with an ECU 100 and an engine 200.

The ECU 100 is provided with a CPU, a ROM, a RAM and the like. The ECU 100 is an electronic control unit capable of controlling all the operations of the engine 200. The ECU 100 is one example of the “vehicle control apparatus” of the present invention. The ECU 100 can perform impulse valve control described later, in accordance with a control program stored in the ROM.

Incidentally, the ECU 100 is a unified or one-body electronic control unit configured to function as one example of each of the “specifying device”, the “controlling device”, the “first correcting device”, and the “second correcting device” of the present invention, and all the operations of the respective devices are performed by the ECU 100. However, the physical, mechanical and electrical configurations of each of the devices of the present invention are not limited to this. For example, each of the devices may be configured as various computer systems such as various controllers or microcomputer apparatuses, various processing units, a plurality of ECUs, and the like.

The engine 200 is an in-line four-cylinder diesel engine as one example of the “internal combustion engine” of the present invention, which runs on light oil. Now the outline of the engine 200 will be explained. The engine 200 has such a structure that four cylinders 202 are disposed in parallel in a cylinder block 201. Moreover, a force generated when an air-fuel mixture spontaneously ignites in a process in which the air-fuel mixture including fuel is compressed in a compression stroke in each cylinder is converted to rotary motion of a crankshaft (not illustrated) via a piston and a connecting rod, each of which is not illustrated. The rotation of the crankshaft is transmitted to the driving wheel of the vehicle with the engine system 10, which enables the driving of the vehicle.

Hereinafter, the structure of a main part of the engine 200 will be explained, together with one portion of its operation. Incidentally, since the structures of the individual cylinders 202 are equal to each other, only one cylinder 202 will be explained here. However, if each cylinder is distinctively expressed, each of the four cylinders will be expressed as a “first cylinder”, a “second cylinder”, a “third cylinder” and a “fourth cylinder.” Incidentally, further to that, in the engine, each stroke is repeatedly performed in order of the first cylinder->the third cylinder->the fourth cylinder->the second cylinder, for the purpose of suppressing vehicle vibration. In other words, if the intake stroke is performed in the first cylinder, the cylinder that will receive the intake stroke in tandem in time series is the third cylinder.

In FIG. 1, incoming air as air led from the outside world is led to an intake tube 204. In the intake tube, a throttle valve 205 capable of adjusting the amount of the incoming air led to the intake tube 204 is placed. The throttle valve 205 is a rotary valve which is electrically connected to the ECU 100 and which can be rotated by a driving force supplied from a throttle valve motor (not illustrated) superiority-controlled by the ECU 100. The rotational position of the throttle valve 205 is continuously controlled from a fully-closed position at which the upstream portion and the downstream portion of the intake tube 204 whose boundary is fixed by the throttle valve 205 are almost blocked, to a fully-opened position at which the upstream portion and the downstream portion are communicated almost entirely. As described above, in the engine 200, the throttle valve 205 and the throttle valve motor constitute a type of electronically-controlled throttle apparatus.

The intake tube 204 is connected to a communicating tube 206 on the downstream side of the throttle valve 205 and is communicated with the communicating tube 206 in the inside of it. The communicating tube 206 is communicated with each of intake ports (not illustrated) of each cylinder 202, and the incoming air led to the intake tube 204 is led to the intake ports corresponding to each cylinder via the communicating tube 206. There are two intake ports provided for one cylinder 202, and each of the intake ports can be communicated with the inside of the cylinder 202. Incidentally, the intake tube 204 and the communicating tube 206 constitute one example of the “intake passage” of the present invention.

In a combustion chamber, the fuel injection valve of a direct injector 203 for fuel injection connected to a not-illustrated common rail is exposed and is configured to directly inject light oil into the cylinder 202. The drive system of the direct injector 203 is electrically connected to the ECU 100 and is superiority-controlled by the ECU 100. In other words, the operations of the direct injector 203 are controlled by the ECU 100. The fuel injected via the direct injector 203 is mixed with the intake air sucked via the intake ports to make the aforementioned air-fuel mixture.

The communication state between the intake port and the inside of the cylinder 202 is controlled by an intake valve 207 disposed in each intake port. The opening/closing characteristics of the intake valve 207 are defined in accordance with the cam profile (simply, shape) of an intake cam 209 which is fixed to an intake cam shaft 208 rotating in tandem with the crankshaft and which forms an oval shape on a cross section perpendicular to a direction of extension of the intake cam shaft 208. The intake valve 207 is configured to communicate the intake port and the inside of the cylinder 202 in valve opening.

On the other hand, the burned air-fuel mixture or partially unburned air-fuel mixture is led to an exhaust manifold 213 as exhaust air via not-illustrated exhaust ports in valve opening of an exhaust valve 210 which opens/closes in tandem with the opening/closing of the intake valve 207. The opening/closing characteristics of the exhaust valve 210 are defined in accordance with the cam profile (simply, shape) of an exhaust cam 212 which is fixed to an exhaust cam shaft 211 rotating in tandem with the crankshaft and which forms an oval shape on a cross section perpendicular to a direction of extension of the exhaust cam shaft 211. The exhaust valve 210 is configured to communicate the exhaust port and the inside of the cylinder 202 in valve opening. The exhaust air integrated in the exhaust manifold 213 is supplied to an exhaust tube 214 communicated with the exhaust manifold 213.

In the exhaust tube 214, a turbine 216 is disposed in a form that it is accommodated in a turbine housing 215. The turbine 216 is a ceramic rotor disc configured to rotate around a predetermined rotating shaft due to the pressure of the exhaust air (i.e. exhaust pressure) led to the exhaust tube 214. The rotating shaft of the turbine 216 is shared with a compressor 218 placed in the intake tube 204 in a form that it is accommodated in a compressor housing 217. If the turbine 216 rotates due to the exhaust pressure, the compressor 218 also rotates around the rotating shaft.

The compressor 218 can pneumatically supply the incoming air sucked into the intake tube 204 from the outside world via a not-illustrated air cleaner, to the downstream side due to the pressure associated with the rotation. By virtue of the pneumatic effect of the incoming air by the compressor 218, so-called supercharging is realized. In other words, in the engine 200, the turbine 216 and the compressor 218 constitute a type of turbocharger.

Moreover, in the exhaust tube 214, a DPF (Diesel Particulate Filter) 219 is placed. The DPF 219 is a so-called wall-flow type filter configured to capture a PM (Particulate Matter) in the exhaust air. Incidentally, on the upstream side and the downstream side of the DPF 219, an oxidation catalyst for stimulating oxidation and combustion of the captured PM may be placed. Alternatively, this oxidation catalyst may be supported by the DPF 219.

In the cylinder block 201 for accommodating the cylinders 202, a water temperature sensor 220 is placed. In the inside of the cylinder block 201, a water jacket as a coolant passage for cooling the cylinders 202 is laid. In the inside of the water jacket, LLC as the coolant is supplied in circulation by the action of a not-illustrated circulatory system. The water temperature sensor 220 has such a structure that one portion of a sensing terminal is exposed to the inside of the water jacket, thereby to detect the temperature of the coolant. The water temperature sensor 220 is electrically connected to the ECU 100, and the detected coolant temperature is gauged by the ECU 100 with a constant or irregular period.

On the upstream side of the compressor 218, an airflow meter 221 of a hot wire type capable of detecting the mass flow of the incoming air is placed. The airflow meter 221 is electrically connected to the ECU 100, and the detected incoming air mass is gauged by the ECU 100 with a constant or irregular period. Incidentally, in the embodiment, the detected incoming air mass has a unique relation with the amount of the intake air (i.e. intake air amount) sucked into the cylinders 202 and is treated as an index value for defining the actual load of the engine 200.

Moreover, in the intake tube 204, an intercooler 222 is placed on the downstream side of the compressor 218 and on the upstream side of the throttle valve 205. The intercooler 222 has a heat exchanger wall in the inside of it. When the supercharged incoming air (which is the same as in a low-revolution area in which the compressor 218 does not operate significantly in practice) passes through, the incoming air can be cooled by heat exchange via the heat exchanger wall. Since the engine 200 can increase the density of the incoming air by using the cooling performed by the intercooler 222, the supercharging via the compressor 218 can be performed, efficiently.

Here, on the downstream side of the throttle valve 205 in the intake tube 204, a surge tank 223 is placed. The surge tank 223 is a retaining device configured to suppress the irregular pulsation of the incoming air supplied while receiving the supercharging action of the turbocharger described above, as occasion demands, to stably supply the incoming air to the downstream side (i.e. the cylinder 202 side), and to invert the phase of a negative-pressure wave in performing inertia supercharging control described later. The aforementioned communicating tube 206 is connected to the intake tube 204 on the downstream side of the surge tank 223. However, since the incoming air is supplied to the cylinder 202 side while pulsating to a greater or lesser extent, the incoming air which passes through the surge tank 223 is also a type of pulsating wave.

In the vicinity of a connection site on the downstream side of the surge tank 223 placed in the intake tube 204, a single impulse valve 224 is placed. The impulse valve 224 is a rotary valve as one example of the “intake control valve” of the present invention which can rotate in one direction in the inside of the intake tube 204. Incidentally, the details of the impulse valve 224 will be described later.

In the vicinity of the impulse valve 224, an actuator 225 capable of applying a driving force used for a change in a valve disc position described above to the impulse valve 224 is placed. The actuator 225 is provided with a drive motor, a motor drive circuit and a rotation angle sensor (all of which are not illustrated).

The drive motor is a DC brushless motor provided with a stator as a stationary part and a not-illustrated rotor as a rotator to which a permanent magnet is attached and which is coupled with the rotating shaft of the valve disc of the impulse valve 224. The drive motor is configured to generate a driving force in the direction of rotation of the rotor, which is rotated by the action of a rotating magnetic field formed in the drive motor due to electrification or power distribution to the stator via the drive circuit.

The motor drive circuit is a current control circuit including an inverter, configured to control the state of the magnetic field formed within the drive motor due to the electrification to the stator. The motor drive circuit is electrically connected to the ECU 100, and its operations are superiority-controlled by the ECU 100. The drive motor is a DC brushless motor. Although its drive voltage is a drive voltage Vdc as a direct-current voltage, its drive current is controlled as a three-phase alternating current corresponding to u phase, v phase and w phase generated by the inverter within the motor drive circuit.

The rotation angle sensor is a so-called resolver configured to detect the rotation angle of the rotor by using a change in voltage outputted from the two-phase coil of the rotor in the drive motor. As described above, the rotor is coupled with the rotating shaft of the valve disc of the impulse valve 224, and the rotor rotation angle detected by the rotation angle sensor has a unique relation with the opening degree of the impulse valve 224. The rotation angle sensor is electrically connected to the ECU 100, and the detected rotor rotation angle is gauged by the ECU 100 with a constant or irregular period as an index value which indicates the opening degree of the impulse valve 224. Incidentally, a device for detecting the opening degree of the impulse valve 224 is not limited to the resolver, and it may be a hall sensor, a rotary encoder, and the like.

To the exhaust manifold 213, one end of an EGR pipe 226 is connected. The other end of the EGR pipe 226 is connected to between the communicating tube 206 and the impulse valve 224 in the intake tube 204, which allows reflux of one portion of the exhaust air led to the exhaust manifold 213, into the communicating tube 206 as an inert EGR gas.

In the EGR pipe 226, an EGR valve 227 is placed. The EGR valve 227 is an electromagnetic opening/closing valve configured to adjust the flow of the EGR gas led to the EGR pipe 226, and its opening/closing state is controlled by the ECU 100 which is electrically connected to the EGR valve 227.

Incidentally, in the engine 200, the communicating tube 206 is integrated on the upstream side of portions corresponding to the individual cylinders 202 (more specifically, intake ports) to realize a so-called one valve type intake system without an intake manifold. However, the structure of the intake system is not limited to this, and it may be such a structure that the intake manifold diverges from the surge tank 223 to the individual cylinders 202. In this case, the impulse valve 224 may be placed in each of the individual intake manifolds, independently and controllably.

Incidentally, the request load of the engine 200 is determined in accordance with an accelerator opening degree Ta as the amount of operation of an accelerator pedal not illustrated (i.e. the amount of operation performed by a driver). The accelerator opening degree Ta is detected by an accelerator opening degree sensor 11 and is referred to by the ECU 100, which is electrically connected to the accelerator opening degree sensor 11, with a constant or irregular period.

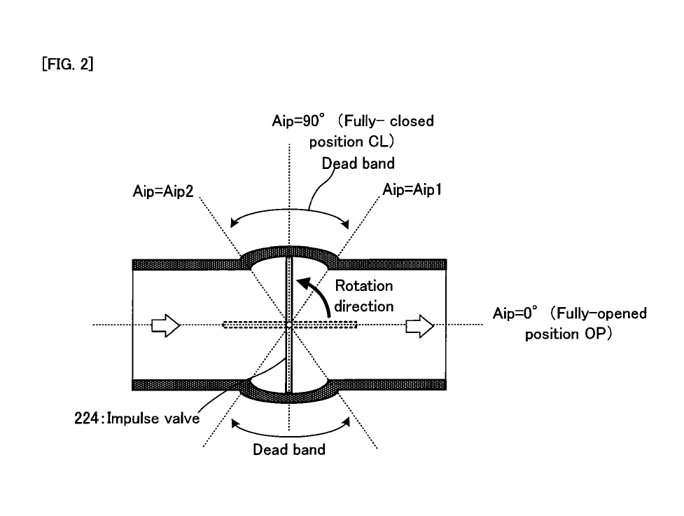

Now, with reference to FIG. 2, the details of the impulse valve 224 will be explained. FIG. 2 is a schematic cross sectional view showing the intake tube 204 near the impulse valve 224. Incidentally, in FIG. 2, portions overlapping those of FIG. 1 will carry the same reference numerals, and the explanation thereof will be omitted as occasion demands.

In FIG. 2, the impulse valve 224 can rotate in an illustrated rotational direction in an illustrated area or surface in the intake tube 224. Incidentally, an illustrated white arrow indicates an incoming airflow direction.

Now, as an index value for defining the rotational state of the impulse valve 224, if an impulse valve rotation angle Aip (i.e. one example of the “rotational phase” of the present invention) is introduced, a case where the impulse valve rotation angle Aip=0 degrees corresponds to a fully-opened position OP, and a phase range in which the impulse valve rotation angle Aip satisfies Aip1≦Aip≦Aip2 corresponds to a fully-closed opening degree CL as one example of the “dead band” of the present invention.

Now, the dead band will be explained. In the dead band, the intake tube 204 is slightly broaden, and if the impulse valve 224 rotates, a gap between the inner wall portion of the intake tube 204 and the end of the impulse valve 224 is kept almost constant. Thus, in the dead band, wherever the impulse valve 224 is, the flow of the incoming air is substantially blocked. In other words, the flow of the incoming air to a right area from the impulse valve 224 is blocked.

### Operations of Embodiment

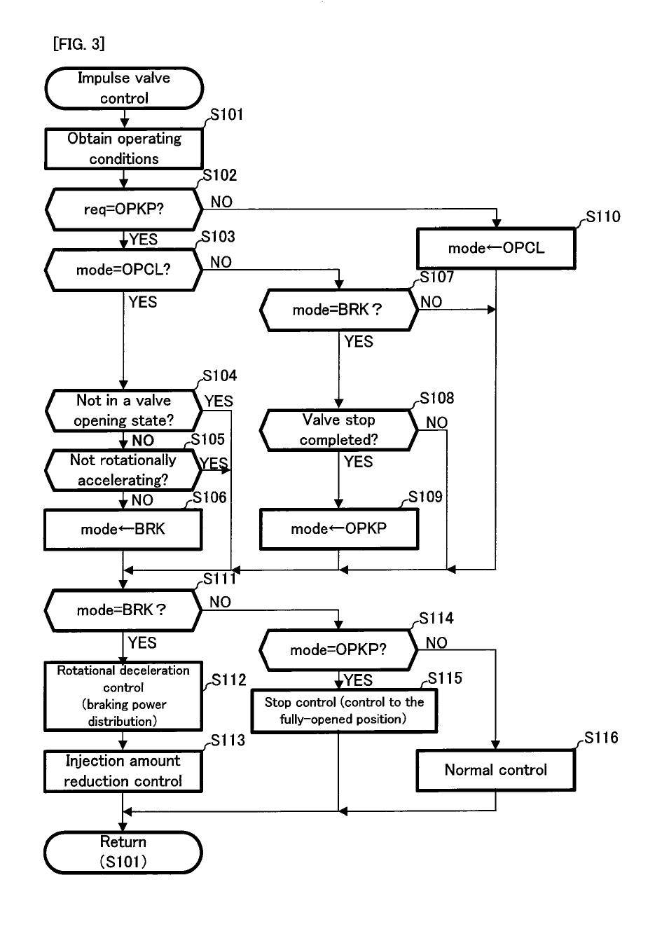

In the engine system 10 having such a structure, the drive state of the impulse valve 224 is controlled by impulse valve control performed by the ECU 100. Now, with reference to FIG. 3, the details of the impulse valve control will be explained. FIG. 3 is a flowchart showing the impulse valve control.

In FIG. 3, the ECU 100 obtains operating conditions of the vehicle (step S101). Incidentally, in the embodiment, an engine rotational speed Ne and the accelerator opening degree Ta are obtained. If obtaining the engine rotational speed Ne and the accelerator opening degree Ta, the ECU 100 determines the operating mode of the impulse valve 224 on the basis of the obtained operating conditions and judges whether or not a request operating mode is an OPKP mode (step S102). At this time, the ECU 100 refers to an operating mode selection map stored in the ROM in advance.

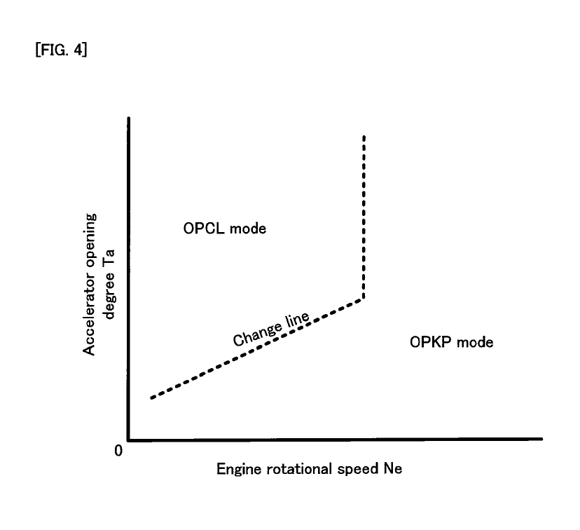

Now, with reference to FIG. 4, the concept of the operating mode selection map will be explained. FIG. 4 is a conceptual view showing the operating mode selection map.

In FIG. 4, the operating mode selection map is a two-dimensional map in which the accelerator opening degree Ta and the engine rotational speed Ne are provided for the vertical axis and the horizontal axis, respectively. On this map, there is set a change line shown in a dashed line. An area on a higher load side or a lower revolution side than the change line is set to an area in which an OPCL mode is to be selected as the operating mode. An area on a lower load side or a higher revolution side than the change line is set to an area in which an OPKP mode is to be selected as the operating mode.

The OPCL (Open-Close) mode selected on the operating mode selection map is an operating mode in which the inertia supercharging is performed by controlling the rotational phase of the impulse valve 224. The inertia supercharging control indicates a series of controls for generating the intake pulsation by rotating the impulse valve 224 and for improving the filling efficiency of the intake air, and its outline will be generally as follows.

In other words, with regard to one cylinder 202 (e.g. first cylinder), if the impulse valve 224 is opened before the start of the intake stroke (i.e. preferably, in termination of another cylinder (e.g. second cylinder)) or at the beginning of the intake stroke, since the impulse valve 224 is opened, the tube-internal pressure of the communicating tube 206 will be negative in accordance with a descent of the piston of the cylinder 202. This increases a pressure difference between the tube-internal pressure of the communicating tube 206 and the tube-internal pressure of the intake tube 204 which is kept at atmospheric pressure or more due to the supercharging. If the impulse valve 224 is opened in the situation that the negative pressure is sufficiently formed within the communicating tube 206 (i.e. if the impulse valve 24 is opened in a valve opening period after the valve opening period of the intake valve 207), the intake tube 204 and the inside of the relevant cylinder (i.e. here, first cylinder) are communicated, and the incoming air is flown into the combustion chamber within the cylinder 202 without stopping as the intake air via the impulse valve 224.

On the other hand, the communicating tube 206 has a so-called open end in a site communicated with the combustion chamber, and a positive-pressure wave caused by the flow of the incoming air into the combustion chamber is reflected at the combustion chamber and it becomes a negative-pressure wave in which the phase is inversed. The negative-pressure wave reaches the surge tank 223 through the communicating tube 206 and the impulse valve 224 in order, is open-end-reflected in a communication hole which is an open end, and reaches the combustion chamber again as a positive-pressure wave in which the phase is inverted. By closing the intake valve 207 at a time point (it is not necessarily limited to this time point, but it may be a constant or irregular period including the time point as long as the filling efficiency can be improved to some extent) at which the peak of the positive-pressure wave reaches the combustion chamber (or the intake valve 207), or by controlling the valve opening time of the impulse valve 224 such that the positive-pressure wave reaches the combustion chamber in timing that the intake valve 207 is closed, the pressure in the combustion chamber increases and the filling efficiency improves. The inertia supercharging using the impulse valve 224 is performed in this manner.

When performing the inertia supercharging, the ECU 100 controls the drive current of the actuator 225 such that the impulse valve 224 rotates in accordance with the change characteristics of the rotational phase determined to improve the filling efficiency of the intake air as much as possible in each operating condition of the vehicle on the basis of experiments, experiences, theories, simulations, or the like in advance.

Incidentally, the engine 200 is a diesel engine; however, if this type of inertia supercharging is applied to a gasoline engine, the amount of the fuel injection is corrected as occasion demands to maintain an air-fuel ratio at a predetermined value in accordance with a change in the amount of the intake air sucked into the cylinders 202. In correcting the amount of the fuel injection, with reference to the amount of correction of the fuel injection amount, which is mapped in association with the opening/closing time of the impulse valve 224 and the operating conditions of the vehicle described above in advance (on the premise that it has the effect associated with the improvement in the filling efficiency of the intake air due to the inertia supercharging), the amount of the fuel injection as a reference is increased as occasion demands. Thus, in performing the inertia supercharging control, it is possible to prevent the deterioration of emission.

On the other hand, the OPKP (OPen-KeeP) mode selected on the operating mode selection map is an operating mode for setting a target rotation angle as the target value of the rotation angle Aip of the impulse valve 224 to 0 degrees, i.e. for stopping the impulse valve 224 at the fully-opened position OP. If the impulse valve 224 is stopped at the fully-opened position OP, the intake pulsation caused by a change in the rotational phase of the impulse valve 224 is not generated. In other words, the impulse valve 224 does not prevent the flow of the intake air, substantially.

Further to that, in a relatively light-load area, the inertia supercharging is not required because it is not necessary to increase the filling amount of the intake air in the first place. In a relatively high-revolution area, the inertia supercharging is forbidden in order to prevent a reduction in the filling efficiency of the intake air because the operating speed of the impulse valve 224 is hardly followed due to a too short time required for the intake stroke of each cylinder.

In the operating mode selection map, the relation illustrated in FIG. 4 is stored in a quantified state. The ECU 100 obtains the operating conditions and determines the request operating mode on the basis of the obtained operating conditions, in the step S101 in FIG. 3.

Here, depending on the obtained operating conditions, a change in the operating mode from the OPCL mode to the OPKP mode is requested in some cases by striding over the illustrated change line. In this case, the impulse valve 224 needs to be position-controlled, quickly and accurately, with the fully-closed position OP as a target position. The ECU 100 is configured to perform a BRK (Brake) mode as the operating mode for that purpose, in addition to the OPCL mode and the OPKP mode. The BRK mode is the operating mode for stopping the impulse valve 224 by supplying a braking force to the impulse valve 224 whose rotational phase continuously changes. The target position at this time is the fully-opened position OP described above. Incidentally, the change request in the operating mode from the OPCL mode to the OPKP mode is one example of the “stop request to stop the inertia supercharging while maintaining the intake control valve in the valve opening state” in the present invention.

Back in FIG. 3, if the request operating mode is the OPKP mode (the step S102: YES), the ECU 100 judges whether or not an active operating mode (i.e. the operating mode that is to be used for the actual control and that is different from the request operating mode) is the OPCL mode (step S103).

If the active operating mode is the OPCL mode (the step S103: YES), the ECU 100 judges whether or not the impulse valve 224 is not in a valve opening state (step S104). If the impulse valve 224 is not in the valve opening state (the step S104: NO), the ECU 100 further judges whether or not the impulse valve 224 is not rotationally accelerating (step S105). If the impulse valve 224 is not rotationally accelerating (the step S105: NO), i.e. if the impulse valve 224 is in the dead band and is decelerating, the ECU 100 sets the active operating mode to the BRK mode (step S106) and moves the process to a step S111. Moreover, if it is in a period for performing the OPCL mode and if the impulse valve 224 is in the valve opening state (the step S104: YES), or if the impulse valve 224 is rotationally accelerating (the step S105: YES), the ECU 100 moves the process to the step S111.

On the other hand, in the step S103, if the active operating mode is not the OPCL mode (the step S103: NO), the ECU 100 judges whether or not the active operating mode is the BRK mode (step S107). If the active operating mode is the BRK mode (the step S107: YES), the ECU 100 further judges whether or not the impulse valve 224 is stopped (step S108).

If the impulse valve 224 completes the stop (the step S108: YES), the ECU 100 sets the active operating mode to the OPKP mode (step S109) and moves the process to the step S111. Moreover, if the impulse valve 224 is still operating (the step S108: NO), the ECU 100 moves the process to the step S111.

On the other hand, in the step S102, if the request operating mode is not the OPKP mode, i.e. if the request operating mode is the OPCL mode (the step S102: NO), the ECU 100 sets the active operating mode to the OPCL mode (step S110) and moves the process to the step S111. Incidentally, in the step S107, if the active operating mode is not the BRK mode (the step S107: NO), i.e. if the active operating mode is not the OPCL mode nor the BRK mode, the process is moved to the step S111 unconditionally.

In the step S111, it is judged whether or not the active operating mode is the BRK mode. If the active operating mode is the BRK mode (the step S111: YES), the ECU 100 performs rotational deceleration control (step S112). Incidentally, the rotational deceleration control means the implementation of a braking power distribution for supplying the driving force in the opposite direction in a regular rotational direction to the impulse valve 224. If performing the rotational deceleration control, the ECU 100 reduces the amount of the fuel injection via the drive control of the direct injector 203 (step S113). If the amount of the fuel injection is reduced, the process is returned to the step S101.

On the other hand, if the active operating mode is not the BRK mode (the step S111: NO), the ECU 100 further judges whether or not the active operating mode is the OPKP mode (step S114). If the active operating mode is the OPKP mode (the step S114: YES), the ECU 100 drive-controls the impulse valve 224 to the fully-opened position OP which is the target position (step S115). Incidentally, if the position is already controlled to the fully-opened position OP, the ECU 100 skips the step S115 (i.e. substantially performs nothing). If the step S115 is performed, the process is returned to the step S101.

Here, in particular, the stop position of the impulse valve 224 when the BKP mode ends is allowed to deviate from the fully-opened position OP as the target position by a width corresponding to an allowed value set in advance (preferably, deviate to the side that the rotation angle increases), by which it is intended to improve a convergence speed. Moreover, by setting such an allowed value, it is possible to suppress an electric power required to stop the impulse valve 224, thereby maintaining or reducing the body of the actuator 225.

On the other hand, the deviation of the rotational phase with respect to a target phase reduces the actual intake amount until it finally reaches the target phase in the OPKP mode. The intake amount in such a transitional period is hardly detected by a detecting device such as an airflow meter. Thus, if no measures are taken, inevitably, the fuel will be excessive and smoke will be generated. Thus, the ECU 100 reduces the amount of the fuel injection as occasion demands in a period for performing the BRK mode. Incidentally, at this time, further in order to smooth the connection of an engine torque before and after the period for performing the BRK mode, the amount of the fuel injection may be corrected to the reduction side when the stop request to stop the inertia supercharging is made.

In the step S114, if the active operating mode is not the OPKP mode (the step S114: NO), i.e. if the active operating mode is the OPCL mode, the ECU 100 continues normal control, i.e. the inertia supercharging using the intake pulsation caused by the change in the rotational phase (step S116). If the step S116 is performed, the process is returned to the step S101. The impulse valve control is performed in the above manner.

As described above, in the impulse valve control, if the request operating mode determined from the operating conditions of the vehicle is the OPCL mode, the inertia supercharging is instantly started. On the other hand, if the request operating mode is changed to the OPKP mode during the period for performing the inertial supercharging (i.e. during the period that the active operating mode is the OPCL mode), the implementation of the BRK mode is postponed until the impulse valve 224 goes into the deceleration state in the dead band. This optimization of the start timing of the BRK mode realizes the quick and efficient change in the operating mode from the OPCL mode to the OPKP mode.

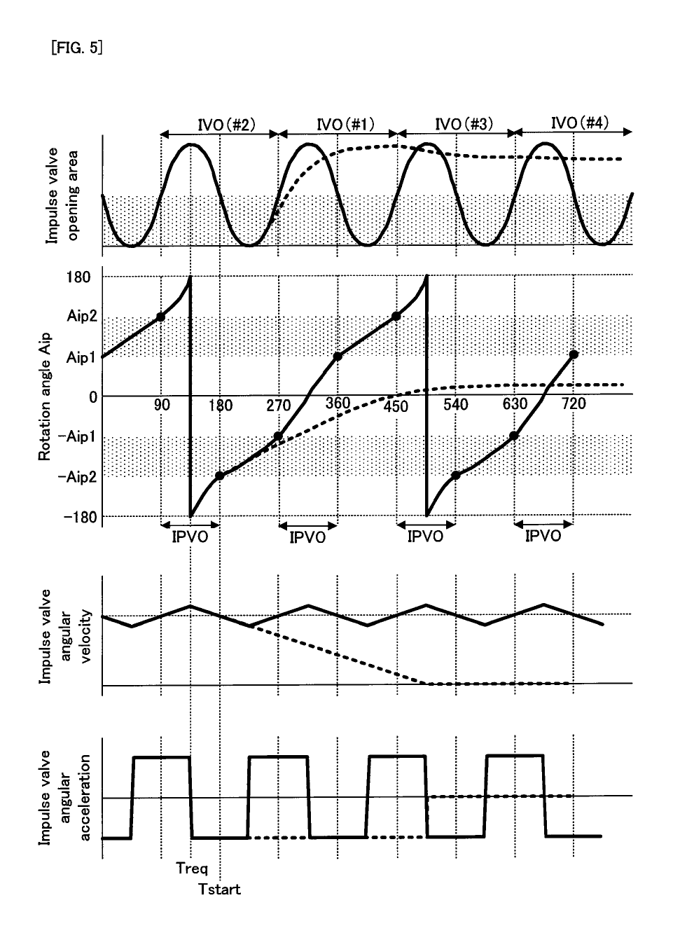

Now, with reference to FIG. 5, the effect of the embodiment as described above will be explained. FIG. 5 is a schematic diagram illustrating a temporal transition in the operating state of the impulse valve 224.

FIG. 5 shows the temporal transition of the opening area of the impulse valve 224, the rotation angle Aip of the impulse valve 224, the angular velocity of the impulse valve 224, and the angular acceleration of the impulse valve from the top in order (refer to a solid line in each case). Incidentally, although having said the temporal transition, the horizontal axis indicates not an absolute time but the crank angle of the engine 200. If the engine rotational speed Ne is constant, the crank angle has the same meaning as the absolute time.

In looking at the temporal transition of the rotation angle Aip of the impulse valve 224, the rotation angle Aip is greater than or equal to Aip1 and is less than or equal to Aip2 in the period that 0 degree CA to 90 degree CA and 360 degree CA to 450 degree CA, and the rotational phase of the impulse valve 224 enters the dead band corresponding to the fully-closed state. In the same manner, the rotation angle Aip is greater than or equal to −Aip2 and is less than or equal to −Aip1 in the period that 180 degree CA to 270 degree CA and 540 degree CA to 630 degree CA, and the rotational phase of the impulse valve 224 enters the dead band. Incidentally, the dead band is shown as a hatched area in FIG. 5. In an area other than the dead band, the impulse valve 224 is opened (refer to “IPVO” illustrated).

On the other hand, since the width of the dead band is less than a valve-opening phase width, the impulse valve 224 is driven at a relatively mild speed in the dead band and at a relatively high speed in the range of the rotational phase corresponding to the valve-opening state. Thus, the angular velocity of the impulse valve 224 decreases in the latter half portion of the phase range corresponding to the valve-opening state (45 degree CA in FIG. 5) and in the former half portion of the dead band connected thereto (45 degree CA in FIG. 5), and the angular velocity increases in the latter half portion of the dead band (45 degree CA in FIG. 5) and in the former half portion of the phase range corresponding to the valve-opening state connected thereto (45 degree CA in FIG. 5). As a result, the angular acceleration substantially proportional to the drive current of the actuator 225 for driving the impulse valve 224 shows a periodic pulse waveform.

Here, it is assumed that the request operating mode is changed from the OPCL mode to the OPKP mode at a time point Treq corresponding to 135 degree CA in the crank angle. In this case, the nearest dead band is 180 degree CA, and the impulse valve 224 is in the deceleration state in the former half portion of the dead band as described above. Thus, the ECU 100 continues the inertia supercharging according to the OPCL mode until the crank angle reaches 180 degree CA and starts the stop control according to the BRK mode at a time point Tstart at which the crank angle reaches 180 degree CA.

The temporal transition of the rotation angle Aip of the impulse valve 224 in cases where such stop control is performed is shown in a dashed line in FIG. 5. In other words, the rotation angle Aip substantially converges on the fully-opened position OP (Aip=0) as the target position, in the valve opening period of the intake valve of the third cylinder (refer to IVO (#3) in FIG. 5). Incidentally, with regard to each of the opening area, the angular velocity and the angular acceleration, the transition corresponding to the stop control is also shown in a dashed line in FIG. 5. Out of them, as is clear from the transition of the angular velocity and the angular acceleration, during the period for performing the BRK mode, the electrification or power distribution for accelerating the impulse valve 224 is forbidden, and a constitutively-constant (or maybe irregular) braking force is supplied. Moreover, as is clear from the comparison between the time waveform (solid line) of the opening area in performing the inertia supercharging and the time waveform of the opening area in performing the stop control, if the embodiment is applied, the cylinder that the intake amount changes with respect to its target is, for example, only the first cylinder. In other words, since the deceleration of the impulse valve 224 is started in a period in which the second cylinder is in the intake stroke with the inertia supercharging (the intake amount does not change due to the dead band), it is possible to complete the position convergence of the impulse valve 224 within the intake stroke of the first cylinder which is the next cylinder, for example with reference to FIG. 5. As a result, the deterioration in the combustion performance of the engine 200 can be suppressed as much as possible.

On the other hand, the supply of the braking force (driving force in a direction of inverse rotation) to the impulse valve 224 is started in the deceleration period of the impulse valve 224. Thus, it is possible to reduce a time required to stop the impulse valve 224 as much as possible, and it is possible to stop the impulse valve 224, highly efficiently and quickly, while maintaining the body of the actuator 225.

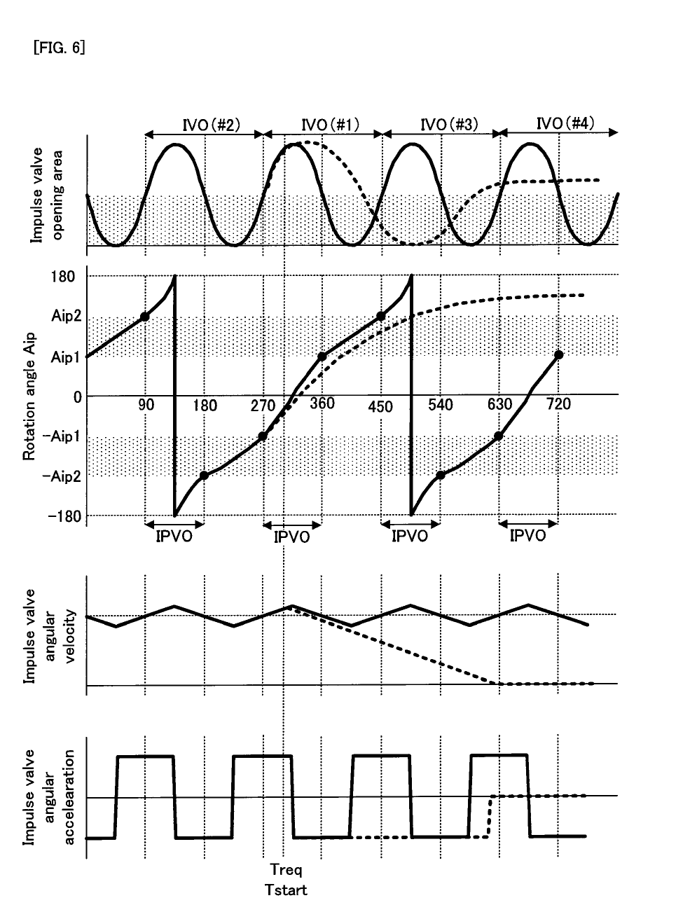

Next with reference to FIG. 6, the effect of the embodiment will be clarified. FIG. 6 is a schematic diagram illustrating a temporal transition of the impulse valve 224 to be used for a comparative study with the embodiment. Incidentally, in FIG. 6, portions overlapping those of FIG. 5 will carry the same reference numerals, and the explanation thereof will be omitted as occasion demands. Incidentally, FIG. 6 is a view corresponding to cases where the braking power distribution according to the BRK mode is performed at a time point at which the stop request to change the operating mode from the OPCL mode to the OPKP mode is made, instead of applying the impulse valve in the embodiment.

In FIG. 6, it is assumed that the braking power distribution is started in the valve-opening period of the impulse valve 224 (near 270 degree CA). In this case, the impulse valve angular velocity is in a reasonably high area, the time required to stop the impulse valve 224 when a certain braking force is applied is longer than that in the embodiment. This results in a longer convergence period of the impulse valve 224 and causes the change in the intake amount over a reasonable period of time. Moreover, since the start timing of the braking power distribution is during the intake stroke of the first cylinder, the intake amount in the intake stroke of the first cylinder increases from an original value. In contrast, in the intake stroke of the third cylinder which is the next cylinder, since the impulse valve 224 is mostly in the dead band, the intake amount significantly decreases. Moreover, since the impulse valve 224 stops in the natural course of events, the stop position is closer to the dead band than the fully-opened position OP, and the sufficient intake amount cannot be obtained even at the convergence time point. This state continues for a while until the position is controlled to the fully-opened position OP, which corresponds to the step S115 in FIG. 3.

As described above, if the impulse valve control in the embodiment is not applied, there will be more likely a plurality of cylinders in which the intake amount changes in stopping the impulse valve 224, and the combustion state of the engine 200 can be deteriorated by that much. Moreover, whether the impulse valve 224 is in the deceleration state or in the acceleration state, the braking power distribution can be performed without change. This increases the position convergence time of the impulse valve 224, and moreover, it tends to deteriorate the convergence accuracy. In other words, according to the impulse valve control in the embodiment illustrated in FIG. 5, since the braking power distribution is started in the deceleration period of the impulse valve 224 in the dead band, the convergence accuracy can be ensured, and the convergence time can be reduced. Moreover, in the point that it is possible to reduce the number of the cylinders that cause the change in the intake amount, it is overwhelmingly advantageous over the aspect that no consideration is given to the start timing of the braking power distribution.

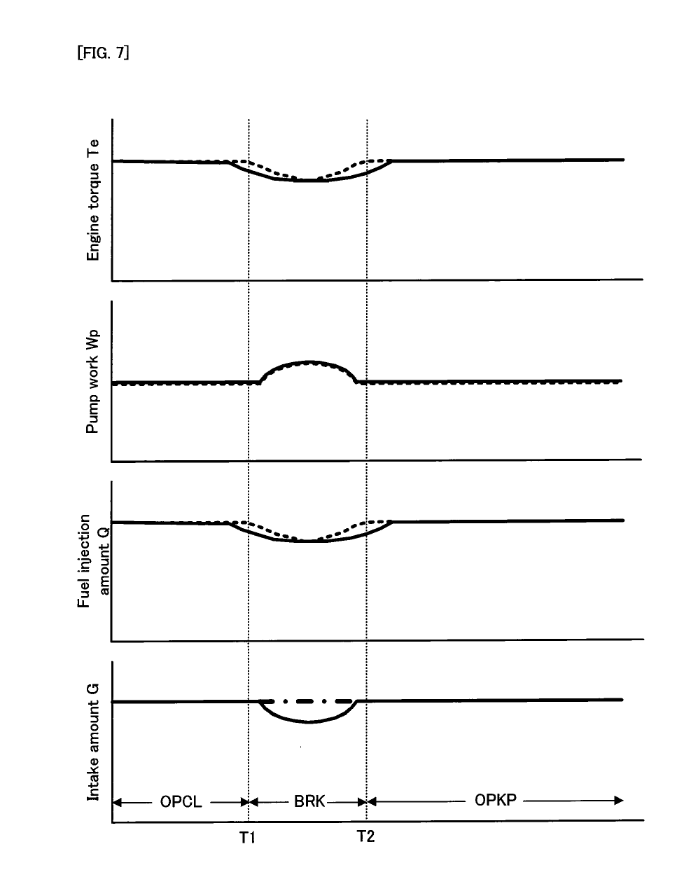

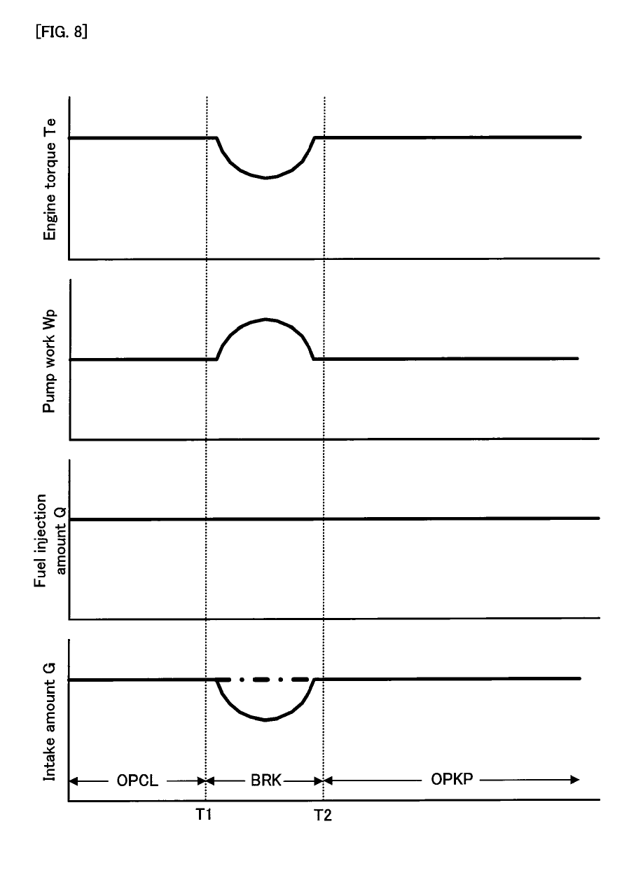

Next, with reference to FIG. 7 and FIG. 8, the additional effect of the embodiment will be explained. FIG. 7 is a schematic diagram illustrating a temporal transition in the operating state of the engine 200 in the process of performing the impulse valve control in FIG. 3. FIG. 8 is a schematic diagram illustrating a temporal transition in the operating state of the engine 200 (comparative example) to be used for a comparative study with the embodiment. Incidentally, in FIG. 7 and FIG. 8, portions overlapping those of each other will carry the same reference numerals, and the explanation thereof will be omitted as occasion demands.

FIG. 7 and FIG. 8 show the temporal transition of each of an engine torque Te, a pump work Wp, a fuel injection amount Q, and an intake amount G, from the top in order.

In FIG. 7, it is assumed that the stop request of the impulse valve 224 (fully-open holding request) is made before a time point T1, that the braking power distribution according to the BRK mode is started as a result of satisfaction with a condition of being in the dead band and a condition of decelerating at the time point T1, and that the impulse valve 224 is stopped at a time point T2 and the operating mode is changed to the OPKP mode.

As described above, according to the impulse valve control in the embodiment, a change in the intake amount G is suppressed, and a reduction in the engine torque Te remains to be relatively small (refer to a dashed line). Moreover, since the fuel injection amount Q is reduced (refer to a dashed line) in the period for performing the BRK mode due to the operation in the step S113, the generation of the smoke caused by the excessive fuel is also suppressed. Moreover, if the fuel injection amount Q is reduced at the time point at which the stop request of the impulse valve 224 is made (i.e. before the BRK mode is actually performed), as shown in a solid line in FIG. 7, the change in the engine torque Te is more smooth, and the generation of a torque shock is suppressed.

On the other hand, as illustrated in FIG. 8, if the impulse valve control in the embodiment is not applied, it provides a large drop in the engine torque Te. Moreover, since an actual reduction change (refer to a solid line) in the intake amount G in this type of transitional period exceeds the detection accuracy of the airflow meter 221, apparently, it is treated as if the intake amount G did not change as shown in an alternate long and short dash line. As a result, the fuel injection amount Q is maintained, and the generation of the smoke caused by the excessive fuel is actualized as an unavoidable problem. Moreover, since the impulse valve 224 has poor convergence accuracy, the pump work Wp relatively increases in the comparative example.

As described above, the application of the impulse valve control in the embodiment provides practically high benefits which are hardly obtained in the comparative example, such as suppressing the reduction in the engine torque Te, reducing the pump work Wp of the engine 200, suppressing the deterioration of emission due to the generation of the smoke, and promoting the smooth change in the engine torque Te.

The present invention is not limited to the aforementioned embodiment, but various changes may be made, if desired, without departing from the essence or spirit of the invention which can be read from the claims and the entire specification. A vehicle control apparatus, which involves such changes, is also intended to be within the technical scope of the present invention.

### INDUSTRIAL APPLICABILITY

The present invention can be applied to, for example, control of a vehicle which is provided with an internal combustion engine and which can perform inertia supercharging using a rotary intake control valve.

1. A vehicle control apparatus for controlling a vehicle, the vehicle comprising: a plurality of cylinders; intake valves each corresponding to respective one of the plurality of cylinders; an intake passage communicated with the plurality of cylinders; a rotary intake control valve which is rotatably disposed in the intake passage and which is in a valve-opening state and a valve-closing state in a predetermined rotational phase; an internal combustion engine which enables inertial supercharging using intake pulsation, by that the rotational phase of the intake control valve is controlled in synchronization with an opening/closing phase of the intake valve; and a braking/driving force supplying device capable of supply a braking/driving force for promoting a change in the rotational phase to the intake control valve,
said vehicle control apparatus comprising:
a specifying device for specifying operating conditions of the vehicle associated with necessity of performing the inertia supercharging; and
a controlling device for controlling the braking/driving force supplying device such that a braking force accompanied by deceleration of the intake control valve is supplied as the braking/driving force if the specified operating conditions correspond to a stop request to stop the inertia supercharging while maintaining the intake control valve in the valve opening state in a period for performing the inertia supercharging and such that the supply of the braking force is started in a dead band indicating a range of the rotational phase corresponding to the valve closing state.

2. The vehicle control apparatus according to claim 1, wherein the intake control valve is supplied with the braking force in a former half portion of the dead band, a driving force accompanied by acceleration of the intake control valve in a latter half portion of the dead band, the driving force in a former half portion of the rotational phase corresponding to the valve opening state connected to the latter half portion of the dead band, and the braking force in a latter half portion of the rotational phase corresponding to the valve opening state connected to the former half portion of the dead band, by the braking/driving force supplying device in the period for performing the inertia supercharging.

3. The vehicle control apparatus according to claim 1, wherein the braking force is supplied by stopping the supply of the driving force or by supplying the driving force in a direction of inverse rotation.

4. The vehicle control apparatus according to claim 1, wherein said controlling device controls the braking/driving force supplying device such that a stop position of the intake control valve resulting from the supply of the braking force is included in an allowable range with respect to a target stop position set in a range of the rotational phase corresponding to the valve opening state.

5. The vehicle control apparatus according to claim 1, further comprising a first correcting device for correcting amount of fuel injection of the internal combustion engine in accordance with a deviation between a stop position of the intake control valve resulting from the supply of the braking force and a target stop position set in a range of the rotational phase corresponding to the valve opening state.

6. The vehicle control apparatus according to claim 1, further comprising a second correcting device for correcting amount of fuel injection of the internal combustion engine to a reduction side if the specified operating conditions correspond to the stop request.
